(19) United States
(12) Patent Application Publication
(10) Pub. No.: US 2024/0375693 A1
(43) Pub. Date: Nov. 14, 2024

(54) Conductor Assembly for Rails

(71) Applicant: ERICO International Corporation, Solon, OH (US)

(72) Inventors: Chad Zaremba, Solon, OH (US); Tobin Most, Medina, OH (US); John Skocdopole, Solon, OH (US); Kevin Reape, Solon, OH (US); John Johnson, Pataskala, OH (US)

(21) Appl. No.: 18/658,534

(22) Filed: May 8, 2024

Related U.S. Application Data
(60) Provisional application No. 63/500,857, filed on May 8, 2023.

(51) Int. Cl. B61L 1/18

(52) U.S. Cl. CPC B61L 1/181

(57) ABSTRACT

A conductor assembly for a rail can include a first conductor and a plurality of second conductors (e.g., with each of the plurality of second conductors having a different length). An exothermic weld can connect a first end of the first conductor to first ends of the second conductors (e.g., three or more second conductors of different lengths).

### CROSS-REFERENCE TO RELATED APPLICATIONS

This application claims priority to and incorporates by reference U.S. Provisional Patent Application No. 63/500,857, filed May 8, 2023.

### BACKGROUND

In many applications, it may be useful to connect conductors to rails of railroad systems, including to conduct signals for track switching and other operations.

### SUMMARY

Some examples of the disclosed technology can provide a conductor assembly for a rail. The conductor assembly can include a first conductor and a plurality of second conductors. An exothermic weld can connect a first end of the first conductor to first ends of the second conductors. In some examples, at least two conductors of the plurality of second conductors can exhibit different lengths between a free end of the respective second conductor and the exothermic weld.

Some examples of the disclosed technology can provide a railroad track circuit assembly. The assembly can include a railroad rail including a web extending between a base and a head. The assembly can include a conductor assembly that includes a first conductor, a plurality of second conductors, and an exothermic weld that may connect a first end of the first conductor to first ends of the second conductors. The first conductor can be coupled to the web of the railroad rail.

Some examples of the disclosed technology can provide a method of forming a conductor assembly for a rail. The method can include forming an exothermic weld to connect a first end of a first conductor to first ends of second conductors. The method may include securing a second free end of the first conductor to the rail, so that the plurality of second conductors extend from the exothermic welded connection to respective second free ends. At least two conductors of the plurality of second conductors may exhibit different lengths between a free end of the respective second conductor and the exothermic weld.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an axonometric view of an example conductor assembly according to the disclosed technology, secured to a railroad rail via welding;

FIG. 2 is an axonometric view of an example conductor assembly according to the disclosed technology, secured to a railroad rail via a fastener connection;

FIG. 3 is an axonometric view of an example conductor assembly according to the disclosed technology, secured to a railroad rail;

FIG. 4 is an isometric view of an example conductor assembly according to the disclosed technology;

FIGS. 5A-5C are side elevation, top plan, and bottom plan views, respectively, of the conductor assembly of FIG. 4;

FIG. 6 is an isometric view of an example conductor assembly according to the disclosed technology;

FIGS. 7A-7C are side, top, and bottom plan views, respectively, of the conductor assembly of FIG. 6;

FIG. 8 is an isometric view of an example conductor assembly according to the disclosed technology; and

FIGS. 9A-9C are side elevation, top plan, and bottom plan views, respectively, of the conductor assembly of FIG. 8.

FIG. 10 is an isometric view of an example conductor assembly according to the disclosed technology.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As noted above, it may be useful to connect conductors to rails of railroad lines (i.e., as used herein, rails that are configured to support train wheels for travel). Such connections can provide signals for track switching, help monitor rail usage, or otherwise be arranged to connect various related devices (e.g., signal or other equipment, other conductors, etc.). Typically, such conductors can include copper cables (e.g., tin-plated copper) or other known arrangements and can be connected to a rail at various locations, including along a web of the rail (i.e., the vertically-extending thinner portion of the rail, between a head portion that contacts passing train wheels and a base that supports and secures the rail relative to the associated tie/sleeper). In many contexts, however, space on the web (or other rail portion) may be limited, including due to the presence of other equipment (e.g., other connected conductors or fixing equipment) or due to thermal effects on the rail from previously formed welded connections. Accordingly, in some cases, it may be difficult to appropriately secure a large number of conductors to a rail at a particular location in a larger rail system.

In some examples, overcrowding of electrical connections on the railroad rail can lead to increased potential of metal fatigue and overall rail degradation. Specifically, mechanically connecting conductors to the rails (e.g., utilizing screws and fasteners) may require workers to drill holes in the railroad rail, and repetitive welding of conductors in a confined space to the rails may cause thermal damage (e.g., formation of martensite). Relatedly, each new electrical connection to a rail can increase a potential for crack formation on the railroad rails. Cracked railroad rails can potentially lead to more frequently required maintenance and costly downtime, e.g., due to shipping delays for companies transporting goods or people by rail. As more and more sensors, switches, and other electrified components require an electrical connection to railroad rails, there exists a need to reduce a number of electrical connection points (e.g., welds, mechanical fasteners, or other known fastening mechanisms) on railroad rails.

A second difficulty related to connecting conductors to railroad rails stems from accidental removal of the conductors during rail operation. For example, trains, railcars, and rail maintenance machines may in some cases include components that extend below a head portion of the railroad rail. These components or others can potentially remove oversized or loose conductors from being connected to the rails, ultimately forcing rail workers to reattach or replace the removed conductors. In some cases, for example if the conductors aid the control of railroad track switching or railroad signals, the removal of the conductors can (again) lead to unexpected maintenance requirements and costly downtime. As such there exists a need to reduce a footprint of conductors connected to the railroad rail, to further reduce the potential of conductors being removed by passing rail vehicles and equipment.

Examples of the disclosed technology may address these and other issues, including by providing robust and adaptably configurable connections between rails and multiple conductors (e.g., multiple cables). For example, some implementations can include a single connecting conductor that is exothermically welded to multiple extending conductors at a common weld structure. The single connecting conductor can then be readily attached to a rail even when limited space on the rail may be available, while still allowing for electrical multiple connections to the rail via the multiple extending conductors (e.g., for different switching or monitoring equipment).

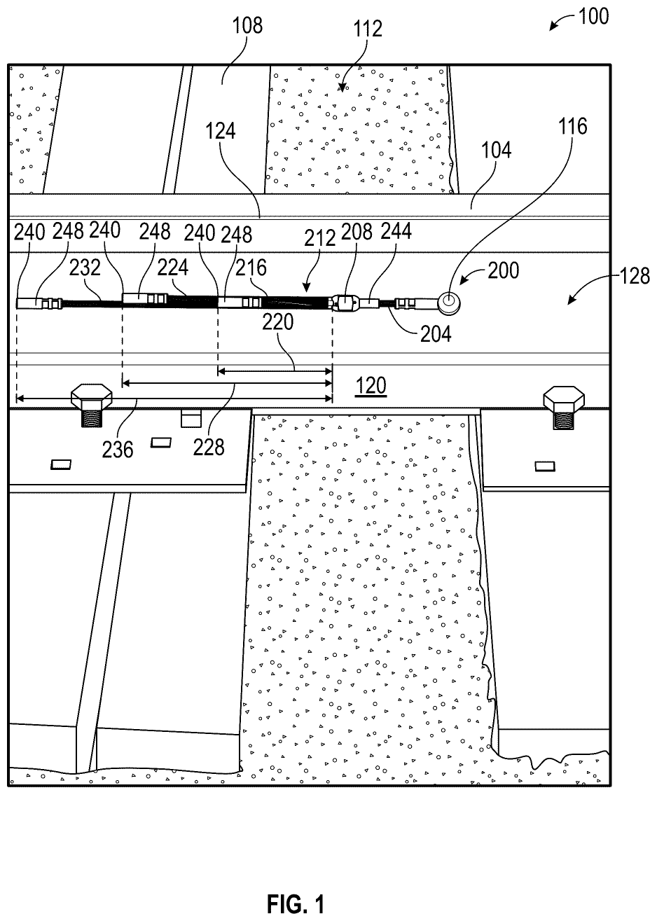

FIG. 1 illustrates an example rail assembly 100 including a railroad rail 104, supported by railroad ties 108, which are in turn supported by railroad ballast 112. The railroad rail 104 may include a web 116 extending between a base 120 and a rail head 124. The base 120 of the rail 104 is secured to the railroad ties 108 to stabilize the rail 104, and the rail head 124 provides a contact surface for wheels of trains (not shown) moving along the railroad assembly 100.

Still referring to FIG. 1, as discussed above, the web 116 of the rail 104 may be an ideal location to connect electrical conductors. For example, a width of the web 116 of the rail 104 measured perpendicular to a length of the rail 104 (e.g., a longest dimension of the rail 104), is generally less than both a width of the base 120 and a width of the rail head 124. The web 116 may therefore provide a recess 128 to receive connections between electrical conductors and the rail 104.

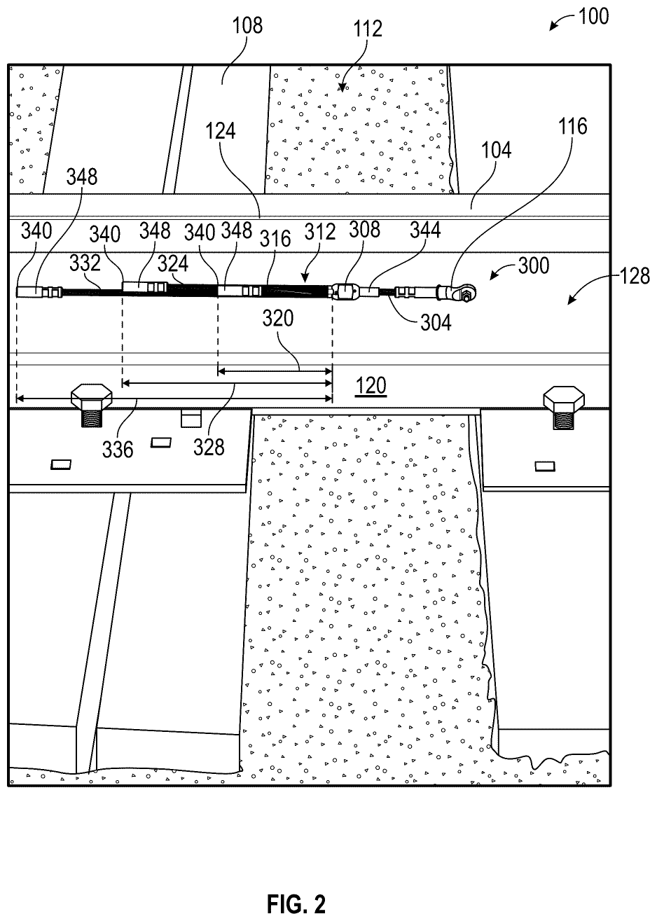

As illustrated in FIGS. 1 and 2, a conductor assembly 200, 300 can be secured to the rail 104. Specifically, as shown, the conductor assembly 200, 300 can be secured to the web 116 of the rail 104. The conductor assemblies 200, 300 can each include a connecting conductor 204, 304 that can be exothermically welded to the rail 104 (see conductor 204, FIG. 1) or mechanically connected to the rail 104 (see conductor 304, FIG. 2) according to various known approaches. Opposite the connection to the rail 104, from a perspective moving along the conductors 204, 304, an exothermic weld 208, 308 connects the connecting conductors 204, 304 to respective ends of a plurality of extending conductors 212, 312 (e.g., with each of the conductors 212, 312 secured by the corresponding weld 208, 308).

Thus, generally, the connecting conductors 204, 304 that are connected to the rail 104 can be connected with the extending conductors 212, 312 for reliable and secure operation relative to electrical conduction and mechanical strength. Connecting more than one extending conductor to a connecting conductor also can increase a number of conductors (and conductor paths) that can be electrically connected to the rail 104 in a limited area of the rail 104, while reducing a number of connection points to the rail 104 (e.g., to a single, common connection point for each of the plurality of extending conductors 212, 312). As described above, reducing a number of connection points between conductors and the rail 104 can help to preserve the integrity and operation of the rail 104. Reducing a number of connection points to the rail 104 can also reduce an amount of time required for rail workers to secure conductors—and associated electrical devices—to the relevant rails (e.g., via welding, mechanical securement, or other known methods).

Referring still to FIGS. 1 and 2, the conductor assemblies 200, 300 each include three of the extending conductors 212, 312 attached to the connecting conductors 204, 304 at the exothermic weld 208, 308. However, in other examples, conductor assemblies can include any desired number of extending conductors. For example, as described below, conductor assemblies can instead include two, three, four, or more extending conductors.

In the illustrated examples of FIGS. 1 and 2, each of the extending conductors 212, 312 extends by a unique (different) length from the corresponding exothermic weld 208, 308. Specifically, a first extending conductor 216, 316, may extend from the exothermic weld 208, 308 by a first distance 220, 320, and a second extending conductor 224, 324 may extend from the exothermic weld 208, 308 by a second distance 228, 328 different from the respective first distance 220, 320. Further, a third extending conductor 232, 332 may extend from the exothermic weld 208, 308 by a third distance 236, 336 different from the respective first distance 220, 320 and the respective second distance 228, 328. As illustrated in FIGS. 1 and 2, the third distance 236, 336 may be longer than the first distance 220, 320 and the second distance 228, 328, while the first distance 220, 320 may be shorter than the second distance 228, 328 and the third distance 236, 336. In other examples, however, other arrangements are possible, including with some conductors extending by the same extension distances.

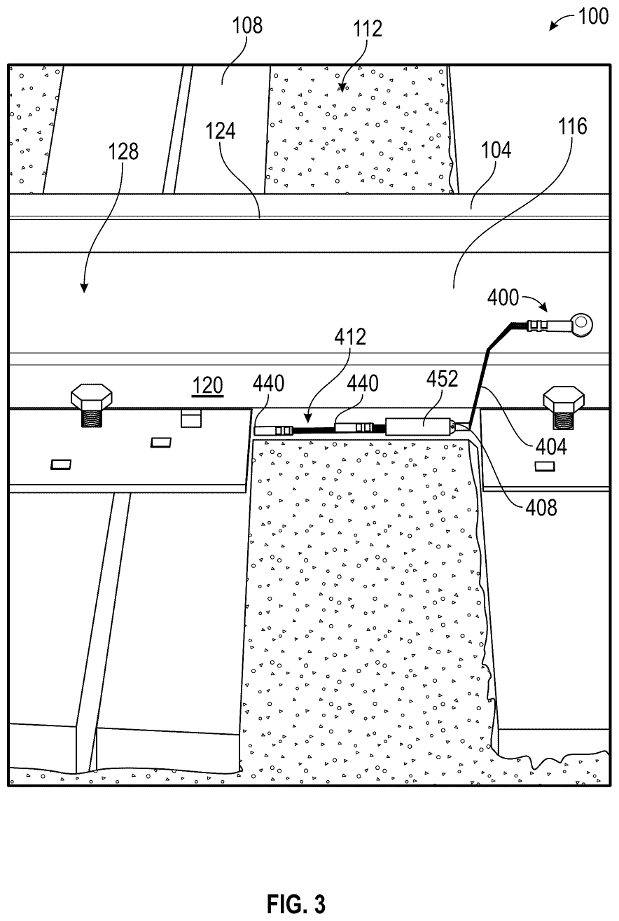

As will be described further below, reducing a footprint of the conductor assemblies 200, 300 may reduce a likelihood of removal of the conductor assembly 200, 300 from the rail 104 by passing rail vehicles and machines. For example, use of an exothermic connection between the connecting conductors 204, 304 and the extending conductors 212, 312 can exhibit a notably small cross-sectional footprint, allowing the assemblies 200, 300 to be easily sleeved and embedded into the ballast 112 below the base 120 of the rail 104 (see FIG. 3).

In some embodiments, each of the extending conductors 212, 312 defining a unique extension distance may help reduce the overall footprint of the conductor assemblies 200, 300. For example, in some configurations, the extending conductors 212, 312 may be configured to communicate a voltage to a plurality of electrical devices (e.g., switches, sensors, railroad bungalows, signaling equipment, or other utilities, not shown). In some embodiments, each of the extending conductors may be configured to communicate voltage to a different respective electrical device of the plurality of electrical devices. Specifically, the extending conductors 212, 312 may be connected to one or more of the electrical devices via operating conductors (e.g., cables) connected at a free end 240, 340 of the extending conductors 212, 312, opposite the exothermic weld 208, 308 (e.g., via crimping, welding, or other known connection method). A connection point between the extending conductors 212, 312 and the operating conductors (not shown) may generally define a greater width than the extending conductors 212, 312. Therefore, staggering the connection points between the extending conductors 212, 312 and the operating conductors (not shown) may mitigate the potential for a clustering of bulky connection points. Accordingly, the staggering of the connection points between the extending conductors 212, 312 and the operating conductors (not shown) may reduce the cross-sectional footprint of the conductor assemblies 200, 300.

In some embodiments, the connecting conductors 204, 304 can include a tensile sleeve 244, 344 attached to an end of the connecting conductors 204, 304. For example, as shown, the tensile sleeve 244, 344 can extend from the end of the connecting conductors 204, 304 disposed within the exothermic welds 208, 308 toward an opposite end of the connecting conductors 204, 304. As illustrated, at least a portion of the tensile sleeve 244, 344 may thus be disposed within the exothermic welds 208, 308. In particular, the tensile sleeves 244, 344 can provide thermal protection to the connecting conductors 204, 304 during welding operations, as well as mechanical support (e.g., tensile support) for the conductors 204, 304 relative to the exothermic welds 208, 308. The tensile sleeves 244, 344 may be secured to the connecting conductors 204, 304 via welding, crimping, or any other known method of securing sleeves to conductors.

In some embodiments, ends of the connecting conductors 204, 304 and the extending conductors 212, 312 opposite the exothermic weld 208, 308 may include end sleeves 248, 348. Similar to the tensile sleeves 244, 344, the end sleeves 248, 348 may be secured to the connecting conductors 204, 304 and the extending conductors 212, 312 via welding, crimping, or any other known method of securing sleeves to conductors. Once secured in place, the end sleeves 248, 348 may provide thermal protection and mechanical support. In some embodiments, the end sleeves 248, 348 may facilitate the connection of the connecting conductors 204, 304 to the rail 104 or connection of the extending conductors 212, 312 to the operating conductors generally described above (e.g., via crimping, welding, or other known method of securing conductors together). However, in other embodiments, one or more of the connecting conductors 204, 304 and the extending conductors 212, 312 may not include end sleeves 248, 348.

In some examples, a connecting conductor can define a variable length to position an exothermic weld connection of a conductor assembly outside of a web of the rail. For example, FIG. 3 exhibits another example assembly 400 that is generally similar to the assemblies 200, 300 discussed above. Accordingly, discussion of the assemblies 200, 300 above generally also applies to the assembly 400, and vice versa, and particularly to like-numbered components in the “400” series. For example, similar to the assemblies 200, 300, the assembly 400 includes a connecting conductor 404 that is connected by an exothermic weld 408 to a plurality of extending conductors 412.

Referring to FIG. 3, in some examples, a length of a connecting conductor 404 between the exothermic weld 408 and the connection point of the connecting conductors 404 to the rail 104 can be varied. For example, as illustrated in FIG. 3, the length of the connecting conductor 404 may be chosen to position the exothermic weld 408 and the extending conductors 412 between the base 120 of the rail 104 and the ballast 112. Tucking the exothermic weld 408 and the extending conductors 412 between the rail 104 and the ballast 112 can reduce a likelihood of removal of the conductor assembly 400 by passing rail vehicles and machines. Furthermore, the small cross-sectional footprint of the conductor assembly 400 may ensure that the exothermic weld 408 and the extending conductors 412 can fit between the rail 104 and the ballast 112. In other examples, such as illustrated in FIGS. 1 and 2, the small cross-sectional footprint of the conductor assembly 200, 300 may instead ensure that the exothermic weld 208, 308 is maintained within the safety of the recess 128 of the rail 104. In other examples, however, other arrangements are possible.

Still referring to FIG. 3, in some examples, to ensure the conductor assembly 400 maintains a small cross-sectional footprint, portions of the conductor assembly (e.g., portions or entire lengths of the connecting conductor 404, the extending conductors 412, and the exothermic weld 408) may be arranged within an organizer sleeve 452 (or other sleeve). The organizer sleeve 452 may be a hose, a heat shrinking sleeve, or any other tube for retaining conductors. The organizer sleeve 452 can protect the conductor assembly 400 while mitigating a chance that one or more of the extending conductors 412 are accidentally repositioned or otherwise altered. As described further below, the conductor assembly 400 may be configured to fit within an organizer sleeve having an interior diameter of less than about 2 inches. In other embodiments, the conductor assembly 400 may be configured to fit within an organizer sleeve having an interior diameter of less than about 2.5 inches, less than about 1.5 inches, less than about 1 inch, or less than about 0.75 inches,

As described above, the extending conductors 412 may each extend a different extension distance from the exothermic weld 408. In some examples, the extending conductors 412 each defining a unique extension distance may ease the task of inserting the extending conductors 412 into the organizer sleeve 452. For example, rail workers attempting to install the organizer sleeve 452 on the example extending conductors 412 may be able to thread the free ends of 440 of the extending conductors 412 through the organizer sleeve 452 one at a time while the organizer sleeve 452 is slid along the extending conductors 412, instead of attempting to insert all of the free ends 440 of the extending conductors 412 into organizer sleeve 452 in a cluster. The variable extension extending conductors 412 may therefore ease installation of the organizer sleeve 452 in the field.

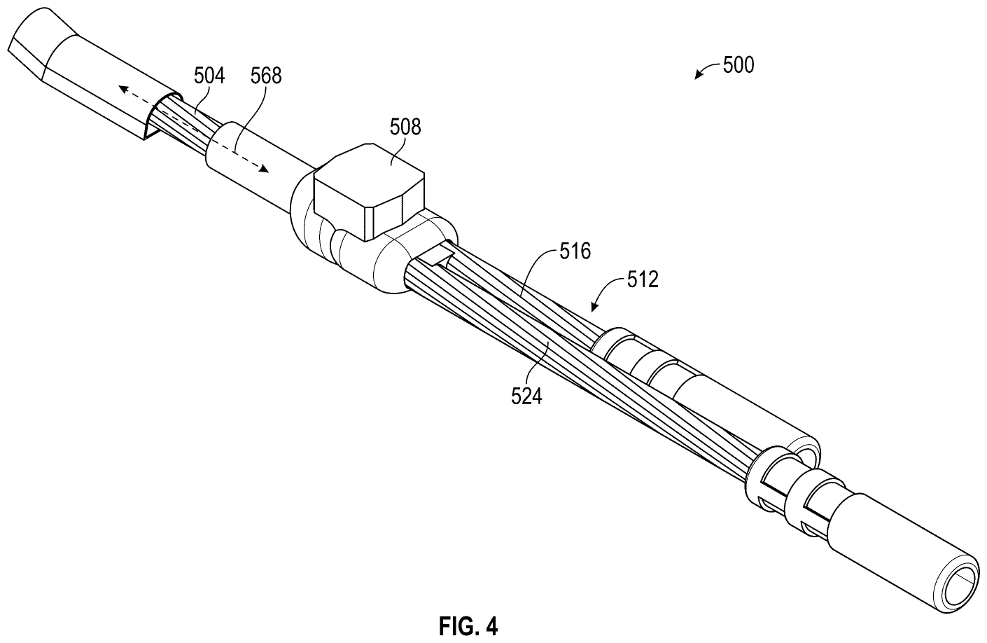

In different examples, a conductor assembly may have different numbers of extending conductors. For example, FIGS. 4-9 exhibit further example assemblies 500, 600, 700 that are generally similar to the assemblies 200, 300, 400 discussed above. Accordingly discussion of the assemblies 200, 300, 400 above generally also applies to the assemblies 500, 600, 700, and vice versa, and particularly to like-numbered components in the “500”, “600” and “700” series. For example, each assembly 500, 600, 700 includes a connecting conductor 504, 604, 704 that is connected by an exothermic weld 508, 608, 708 to a plurality of extending conductors 512, 612, 712. As described below, each of the assembly 500, 600, 700 may include various numbers of the extending conductors 512, 612, 712.

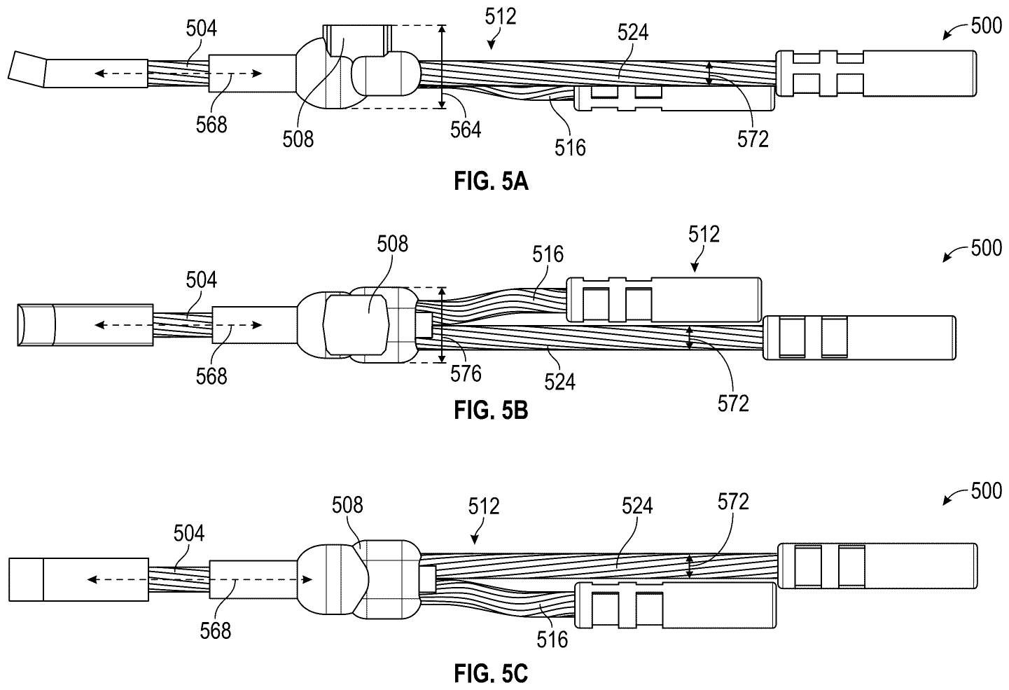

Referring to FIGS. 4-5C, in some examples, extending conductors 512 of the conductor assembly 500 may include a first extending conductor 516 and a second extending conductor 524 each defining a unique extension distance. As illustrated in FIGS. 4 and 5B in particular, the first and second extending conductors 516, 524 can be positioned in a side by side array within the exothermic weld 508 (from a top plan perspective) to reduce a cross-sectional footprint of the exothermic weld 508 and therefore the conductor assembly 500.

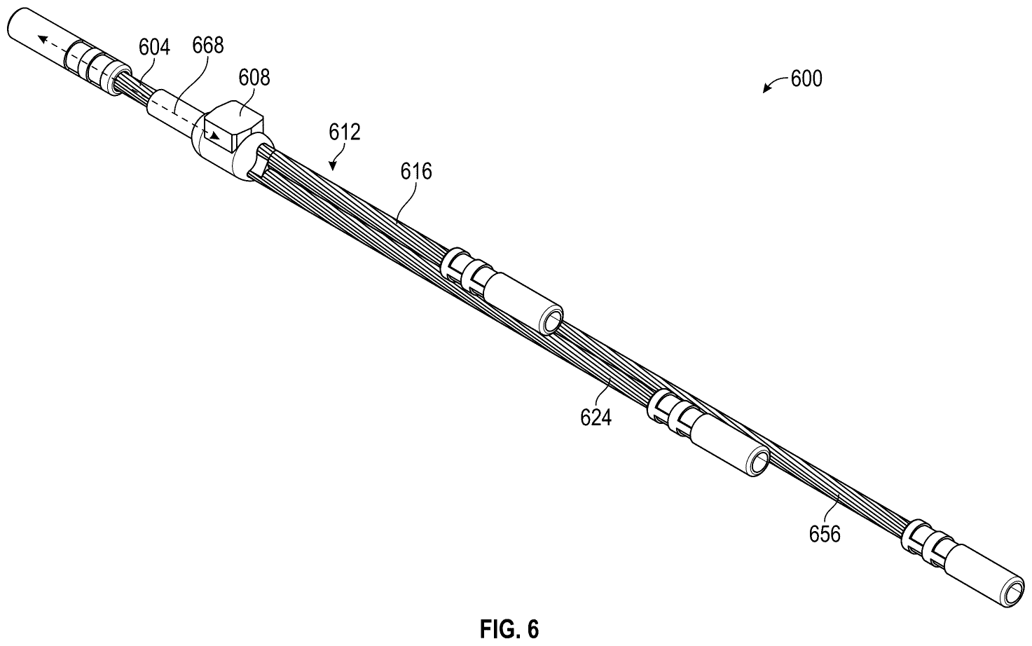

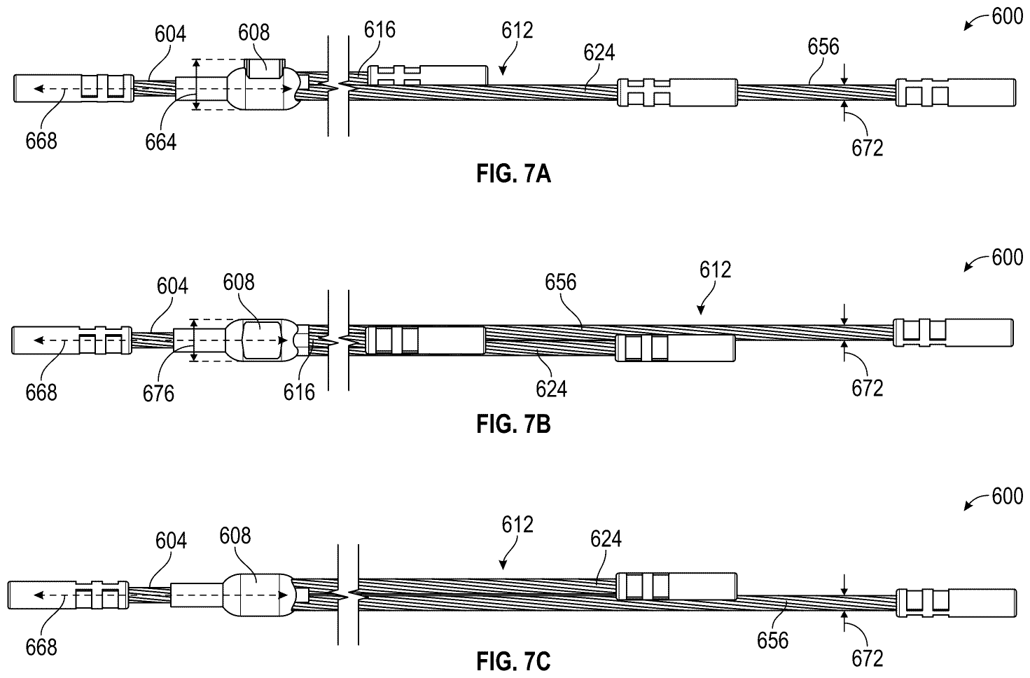

Referring to FIGS. 6-7C, in some examples, extending conductors 612 the conductor assembly 600 may include a first extending conductor 616, a second extending conductor 624, and a third extending conductor 656 each defining a unique extension distance. As illustrated in FIG. 6, the first, second, and third extending conductors 616, 624, 656 can be positioned within the exothermic weld 608 in a triangular shaped array to reduce a cross-sectional footprint of the exothermic weld 608 and therefore the conductor assembly 600. In some examples, a triangle configuration for the plurality of extending conductors 612 may provide a most efficient shape for organizing the extending conductors 612 within the exothermic weld 608.

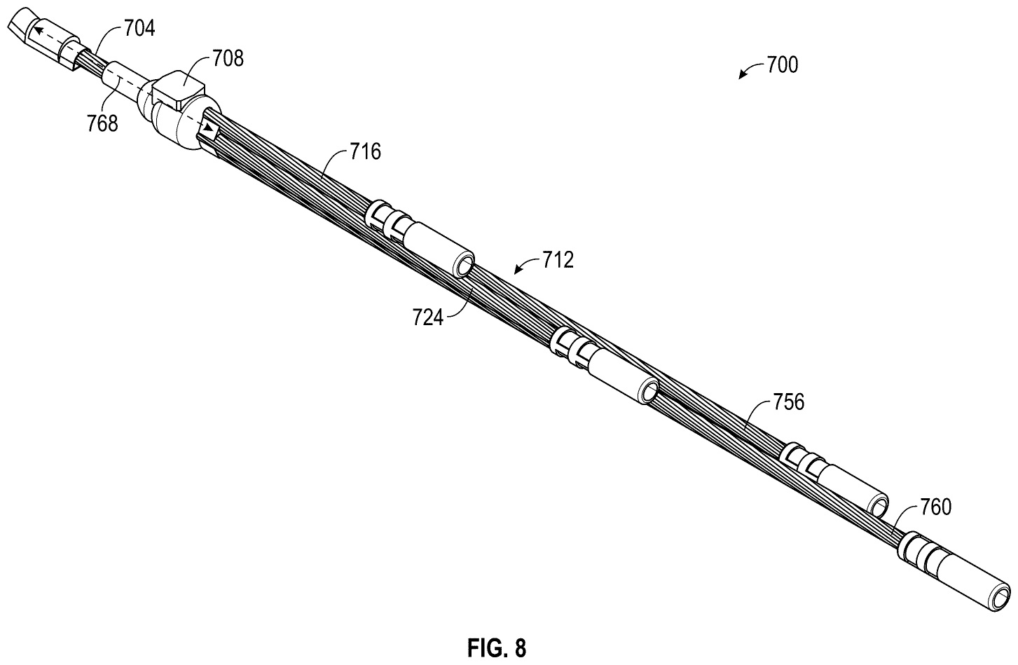

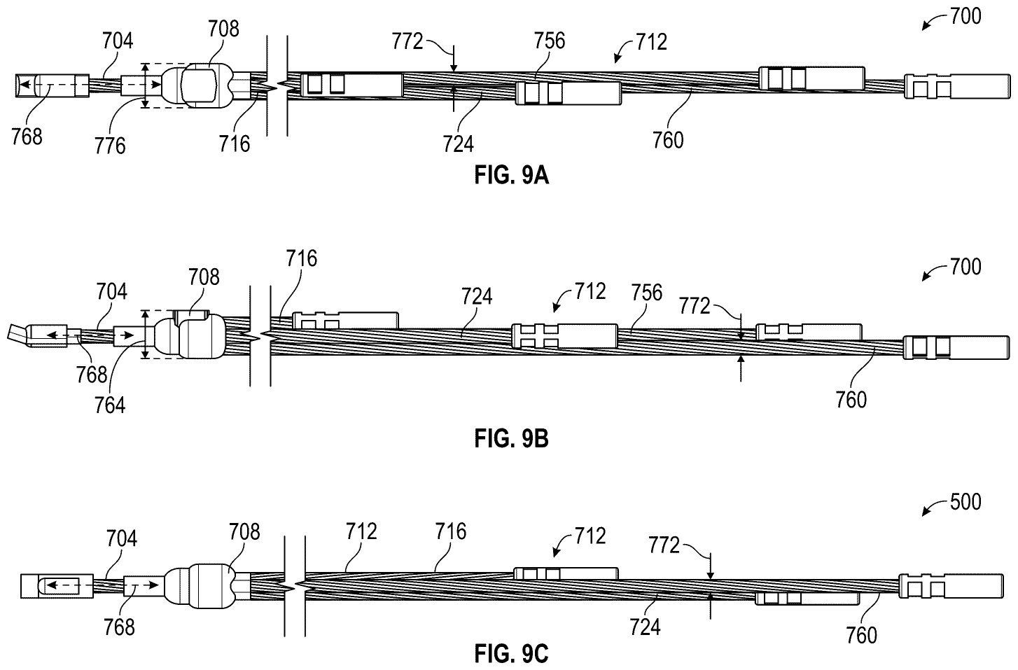

Referring to FIGS. 8-9C, in some examples, extending conductors 712 of the conductor assembly 700 may include a first extending conductor 716, a second extending conductor 724, a third extending conductor 756, and a fourth extending conductor 760 each defining a unique extension distance. As illustrated in FIG. 8, the first, second, third, and fourth extending conductors 716, 724, 756, 760 can be positioned within the exothermic weld 608 in a diamond shaped array to reduce a cross-sectional footprint of the exothermic weld 708 and therefore the conductor assembly 600. In some examples, a diamond configuration for the plurality of extending conductors 712 may provide a most efficient shape for organizing the extending conductors 712 within the exothermic weld 708.

As described above, it can be advantageous to reduce a cross-sectional footprint of the conductor assembly 500, 600, 700 to ensure the conductor assembly 500, 600, 700 can be embedded between the railroad rail 104 and the ballast 112 (as illustrated in FIG. 3), or within the recess 128 of the rail 104 (as illustrated in FIGS. 1 and 2). In the illustrated embodiments of FIGS. 4-9C, it may be advantageous to limit a thickness of the exothermic weld 508, 608, 708. For example, a first thickness 564, 664, 764 of the exothermic weld 508, 608, 708 may be measured substantially perpendicular to a center axis 568, 668, 768 extending axially through a center of the corresponding connecting conductor 504, 604, 704 (see FIGS. 5A, 7A, 9A). In some embodiments, the first thickness 564, 664, 764 may be less than about 3.5 times a corresponding conductor thickness 572, 672, 772 (e.g., a diameter) of a corresponding one of the plurality extending conductors 512, 612, 712. In some embodiments, the first thickness 564, 664, 764 may be less than about 3 times the corresponding conductor thickness 572, 672, 772, less than about 4 times the corresponding conductor thickness 572, 672, 772, or less than about 5 times the corresponding conductor thickness 572, 672, 772. Limiting a width of the exothermic weld 508, 608, 708 relative to the thickness of the extending conductors 512, 612, 712 can ensure the exothermic weld 508, 608, 708 does not include excessive weld material, particularly when employed in combination with optimized conductor array geometry (e.g., as discussed above). Additionally, in some embodiments, the first thickness 564, 664, 764 may specifically be a maximum thickness of the exothermic weld 508, 608, 708 in all directions or in all directions perpendicular to the corresponding center axis 568, 668, 768. However, in other embodiments, the first thickness 564, 664, 764 may not be the maximum thickness of the exothermic weld 508, 608, 708.

Referring still to FIGS. 4-9C, in some embodiments, it may be advantageous to limit a thickness of the exothermic weld 508, 608, 708 relative to a web of a railroad rail. For example, similar to the conductor assembly 200, 300 described above, the conductor assembly 500, 600, 700 may be attached to a railroad rail having a web that defines a height (see, generally, FIGS. 1-3). In some embodiments, the first thickness 564, 664, 764 may be less than about ¼ of a height of the web of the railroad rail. In some embodiments, the first thickness 564, 664, 764 may be less than about ⅜, less than about ⅓, or less than about ⅕ of the height of the web of the railroad rail. Limiting the size of the exothermic weld 508, 608, 708 relative to a dimension of the railroad rail may help to ensure that the exothermic weld 508, 608, 708 can be appropriately (e.g., fully) embedded between the railroad rail 104 and the ballast 112 (e.g., as illustrated in FIG. 3), or within the recess 128 of the rail 104 (e.g., as illustrated in FIGS. 1 and 2).

Referring still to FIGS. 4-9C, in some embodiments, it may be advantageous to limit a second thickness 576, 676, 776 of the exothermic weld 508, 608, 708 that is measured in a second direction substantially perpendicular to the first thickness 564, 664, 764 (and the center axes 568, 668, 768). In some embodiments a ratio of the first thickness 564, 664, 764 to the second thickness 576, 676, 776 may be less than about 1.2. In some embodiments, the ratio of the first thickness 564, 664, 764 to the second thickness 576, 676, 776 may be less than about 1.4, less than about 1.6, less than about 1.8, or less than about 2. Limiting a width of the exothermic weld 508, 608, 708 in two directions that are perpendicular to one another may ensure the exothermic weld 508, 608, 708 can be embedded between the railroad rail 104 and the ballast 112 (as illustrated in FIG. 3), or within the recess 128 of the rail 104 (as illustrated in FIGS. 1 and 2) in multiple orientations, aiding the flexibility of installation.

Referring still to FIGS. 4-9C, in some embodiments it may be advantageous to limit a thickness of the exothermic weld 508, 608, 708, to ensure the exothermic weld 508, 608, 708 can fit within an organizer sleeve (e.g., similar to the organizer sleeve 452). Therefore, in some embodiments, the first thickness 564, 664, 764, the second thickness 576, 676, 776, or, generally, a maximum thickness of the assembly 600 or the weld 508, 608, 708 measured perpendicular to the corresponding center axis 568, 668, 768 may be less than about 2 inches. In some embodiments, the first thickness 564, 664, 764, the second thickness 576, 676, 776 or a maximum thickness (as noted above) may instead be less than about 1.5 inches, less than about 1 inch, or less than about 0.75 inches.

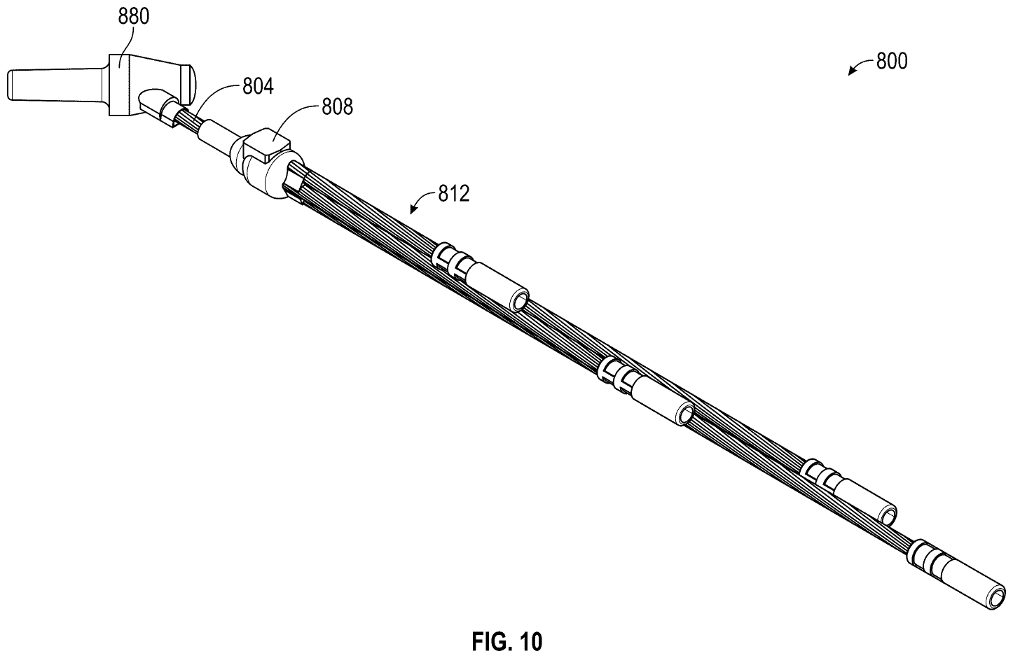

In some examples, a conductor assembly can be connected to a rail using an alternate securing mechanism than those illustrated in FIGS. 1-9C. For example, FIG. 10 exhibits another example assembly 800 that is generally similar to the assemblies 200, 300, 400, 500, 600, 700 discussed above. Accordingly, discussion of the assemblies 200, 300, 400, 500, 600, 700 above generally also applies to the assembly 800, and vice versa, and particularly to like-numbered components in the “800” series. For example, similar to the assemblies 200, 300, 400, 500, 600, 700, the assembly 800 includes a connecting conductor 804 that is connected by an exothermic weld 808 to a plurality of extending conductors 812.

As illustrated in FIG. 10, in some examples, the connecting conductor 804 may be connected to a plug 880 at an end of the connecting conductor 804 that is opposite the exothermic weld 808. In some embodiments, the plug 880 may be utilized to secure the assembly 800 to the rail 104 (e.g., driven into a hole in the rail or otherwise secured to the rail using various known approaches).

Thus, examples of the disclosed technology can provide improved systems for connections to rails. For example, a single conductor that is configured to be secured to a rail can also be secured via exothermic welding to multiple extending conductors. Accordingly, a single exothermic or mechanical connection between a conductor and a rail can provide electrical connections for multiple devices or systems, with a high degree of conductivity and mechanically security.

It is appreciated that the conductors described above may define any length, and the illustrated embodiments are not to scale.

In some implementations, devices or systems disclosed herein can be utilized, manufactured, installed, etc. using methods embodying aspects of the disclosed technology. Correspondingly, any description herein of particular features, capabilities, or intended purposes of a device or system should be considered to disclose, as examples of the disclosed technology a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, should be understood to disclose, as examples of the disclosed technology, the utilized features and implemented capabilities of such device or system. In this regard, for example, embodiments of the invention can include manufacturing any of the assemblies 200, 300, 400, 500, 600, 700 discussed above and installing any of the assemblies 200, 300, 400, 500, 600, 700 using the illustrated (or other) securing mechanism to attach the connecting conductor to a rail and using the illustrated (or other) structures to connect the extension conductors to corresponding electrical devices or other conductors.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

Also as used herein, unless otherwise specified or limited, directional terms are presented only with regard to the particular embodiment and perspective described. For example, reference to features or directions as “horizontal,” “vertical,” “front,” “rear,” “left,” “right,” “upper,” “lower,” and so on are generally made with reference to a particular figure or example and are not necessarily indicative of an absolute orientation or direction. However, relative directional terms for a particular embodiment may generally apply to alternative orientations of that embodiment. For example, “front” and “rear” directions or features (or “right” and “left” directions or features, and so on) may be generally understood to indicate relatively opposite directions or features for a particular embodiment, regardless of the absolute orientation of the embodiment (or relative orientation relative to environmental structures). “Lateral” and derivatives thereof generally indicate directions that are generally perpendicular to a vertical direction for a relevant reference frame.

Also as used herein, ordinal numbers are used for convenience of presentation only and are generally presented in an order that corresponds to the order in which particular features are introduced in the relevant discussion. Accordingly, for example, a “first” feature may not necessarily have any required structural or sequential relationship to a “second” feature, and so on. Further, similar features may be referred to in different portions of the discussion by different ordinal numbers. For example, a particular feature may be referred to in some discussion as a “first” feature, while a similar or substantially identical feature may be referred to in other discussion as a “third” feature, and so on.

As used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Unless otherwise limited or defined, the terms “about” and “approximately,” as used herein with respect to a reference value, refer to variations from the reference value of ±20% or less (e.g., ±15, ±10%, ±5%, etc.), inclusive of the endpoints of the range. Similarly, as used herein with respect to a reference value, the term “substantially equal” (and the like) refers to variations from the reference value of less than ±5% (e.g., ±2%, ±1%, ±0.5%) inclusive.

Unless otherwise limited or defined, “substantially parallel” indicates a direction that is within ±12 degrees of a reference direction (e.g., within ±6 degrees or ±3 degrees), inclusive. Correspondingly, “substantially vertical” indicates a direction that is substantially parallel to the vertical direction, as defined relative to gravity, with a similarly derived meaning for “substantially horizontal” (relative to the horizontal direction). Likewise, unless otherwise limited or defined, “substantially perpendicular” indicates a direction that is within ±12 degrees of perpendicular a reference direction (e.g., within ±6 degrees or ±3 degrees), inclusive.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

We claim:

1. A conductor assembly for a railroad rail, the conductor assembly comprising:
a first conductor;
a plurality of second conductors; and
an exothermic weld that connects a first end of the first conductor to first ends of the second conductors,
wherein at least two conductors of the plurality of second conductors exhibit different lengths between a free end of the respective second conductor and the exothermic weld.

2. The conductor assembly of claim 1, wherein the plurality of second conductors includes three or more conductors.

3. The conductor assembly of claim 1, wherein each of the plurality of second conductors exhibits a different length between a free end of the respective second conductor and the exothermic weld.

4. The conductor assembly of claim 1, wherein the first conductor is secured to the rail with a mechanical or welded connection.

5. The conductor assembly of claim 1, wherein a first thickness of the exothermic weld measured substantially perpendicular to an axial direction of the first conductor is less than 3.5 times a thickness of one of the plurality second conductors.

6. The conductor assembly of claim 5, wherein the plurality of second conductors are arranged within a sleeve having a diameter of less than two inches.

7. The conductor assembly of claim 1, wherein a tensile sleeve extends from the first end of the first conductor toward a second end of the first conductor, and wherein at least a portion of the tensile sleeve is positioned within the exothermic weld.

8. The conductor assembly of claim 1, wherein a first thickness of the exothermic weld is measured in a first direction substantially perpendicular to an axial direction of the first conductor, a second thickness of the exothermic weld is measured in a second direction substantially perpendicular to the first direction and the axial direction, and a ratio of the first thickness to the second thickness is less than two.

9. The conductor assembly of claim 1, wherein a first thickness of the exothermic weld measured substantially perpendicular to an axial direction of the first conductor is less than one quarter of a height of a web of the railroad rail.

10. A railroad track circuit assembly, the assembly comprising:
a railroad rail including a web extending between a base and a head;
a conductor assembly including:
a first conductor;
a plurality of second conductors; and
an exothermic weld that connects a first end of the first conductor to first ends of the second conductors;
wherein the first conductor is coupled to the web of the railroad rail.

11. The assembly of claim 10, wherein the first conductor extends from the web of the railroad rail to position the exothermic weld below the base of the railroad rail.

12. The assembly of claim 10, wherein the first conductor is configured to communicate a voltage from the railroad rail to a plurality of electrical devices via the plurality of second conductors, with each second conductor of the plurality of second conductors in communication with a different respective electrical device of the plurality of electrical devices.

13. The assembly of claim 10, wherein the exothermic weld and the plurality of second conductors are arranged within a sleeve.

14. The assembly of claim 10, wherein at least two conductors of the plurality of second conductors exhibit different lengths between a free end of the respective second conductor and the exothermic weld.

15. A method of forming a conductor assembly for a rail, the method comprising:
forming an exothermic weld to connect a first end of a first conductor to first ends of a plurality of second conductors; and
securing a second free end of the first conductor to the rail, so that the plurality of second conductors extend from the exothermic welded connection to respective second free ends;
wherein at least two conductors of the plurality of second conductors exhibit different lengths between a free end of the respective second conductor and the exothermic weld.

16. The method of claim 15, further comprising:
attaching to a first of the second conductors a first connection to a first electrical device, attaching to a second of the second conductors a second connection to a second electrical device.

17. The method of claim 15, further comprising:
arranging the exothermic welded connection under a base of the rail.

18. The method of claim 15, further comprising:
securing a tensile sleeve to the first free end of the first conductor.

19. The method of claim 15, wherein each of the plurality of second conductors exhibits a different length between a second free end of the respective second conductor and the first free end of the second conductors.

20. The method of claim 15, wherein a first thickness of the exothermic weld measured substantially perpendicular to an axial direction of the first conductor is less than 4 times a maximum thickness of one of the plurality second conductors.
